(19) United States
(12) Patent Application Publication
(10) Pub. No.: US 2025/0378307 A1
(43) Pub. Date: Dec. 11, 2025

(54) UNIVERSAL EMBEDDING BASED ENTITY RETRIEVAL MODEL

(71) Applicant: Microsoft Technology Licensing, LLC, Redmond, WA (US)

(72) Inventors: Zhanglong LIU, Fremont, CA (US); Keren WANG, Mountain View, CA (US); Smriti R. RAMAKRISHNAN, Belmont, CA (US); Yan GAO, Los Altos, CA (US); Xiaotian ZHAN, Santa Clara, CA (US); Parag AGRAWAL, Santa Clara, CA (US); Rajvardhan Sanjay KAPADNIS, San Francisco, CA (US)

(21) Appl. No.: 18/736,746

(22) Filed: Jun. 7, 2024

(51) Int. Cl. G06N 3/0455; G06N 3/084

(52) U.S. Cl. CPC G06N 3/0455; G06N 3/084

(57) ABSTRACT

Aspects of the disclosure include methods for leveraging a universal embedding based entity retrieval deep learning model for candidate recommendations. A method can include receiving a request for a candidate pair having a first entity and a second entity and generating a filtered candidate pool including a first number of candidates. The filtered candidate pool can include a subset of an initial candidate pool having a second number of candidates larger than the first number of candidates. A learned distance function is selected from a plurality of distance functions. At least one distance function was predetermined prior to receiving the request and at least one distance function is generated in response to receiving the request. A distance measure is determined for each candidate in the filtered candidate pool using the learned distance function and a response is returned including top K candidates according to the determined distance measures.

### INTRODUCTION

The subject disclosure relates to machine learning, deep learning, and entity retrieval, and specifically to a universal embedding based entity retrieval (EER) deep learning model.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a universal embedding based entity retrieval (EER) model in accordance with one or more embodiments;

FIG. 2 depicts a block diagram for an example transformer-based architecture in accordance with one or more embodiments;

FIG. 3 depicts a block diagram for an example distance function selection module in accordance with one or more embodiments;

FIG. 4A depicts a block diagram for an example simple distance model in accordance with one or more embodiments;

FIG. 4B depicts a block diagram for an example user-defined function (UDF) distance model in accordance with one or more embodiments;

FIG. 5 depicts a block diagram for an example single embedding distance function deep learning model in accordance with one or more embodiments;

FIG. 6 depicts a block diagram for an example multiple embedding distance function deep learning model in accordance with one or more embodiments;

FIG. 7 depicts a block diagram for an example embedding feature period and label period design in accordance with one or more embodiments;

FIG. 8 depicts a block diagram for an example e deep learning structure in accordance with one or more embodiments;

FIG. 9 depicts a block diagram of a computer system according to one or more embodiments; and

FIG. 10 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Deep learning is a subfield of machine learning that focuses on learning representations of data through neural networks with multiple layers. Deep learning models are designed to automatically learn hierarchical representations of input data and are often characterized by their depth, which refers to the number of layers in the underlying neural network. Deep learning models can consist of multiple layers of interconnected neurons, with each layer extracting increasingly complex and abstract features from the input data. These models have achieved remarkable success in various tasks, especially in areas such as computer vision, natural language processing (NLP), speech recognition, and reinforcement learning.

Entity Retrieval, also referred to as information retrieval, is a fundamental task in the field of deep learning and refers generally to the identification and retrieval of relevant entities from a given corpus or knowledge base according to a user's query or query context. Deep learning models can rely on entity retrieval in several ways to enhance their performance and capabilities. For example, deep learning models can leverage entity retrieval to ground their output in factual knowledge. By retrieving relevant entities from a knowledge base or corpus during the generation process (or scoring process), deep learning models can produce more accurate and consistent responses, especially for question-answering or knowledge-intensive tasks. Entity retrieval can also be used for entity linking and disambiguation, which involves identifying and linking mentions of entities in text to their corresponding entries in a knowledge base, and when handling multimodal entity representations, as entity retrieval can be used to gather relevant multimodal information about entities, which can then be fused and processed by a deep learning model.

In deep learning models having traditional entity retrieval systems, the retrieval process has primarily been based on keyword matching. In keyword matching architectures, queries and data (e.g., documents) are represented as bags of words, and relevance is determined by the degree of overlap between the query term(s) and the document term(s). However, this type of approach often fails to capture the semantic relationships between words and the underlying meaning of a text.

Embedding-based Entity Retrieval (EER) aims to overcome this and other limitations by empowering deep learning models to represent entities and queries in a dense, continuous vector space. These vector spaces, often referred to as embedding spaces, capture the semantic and contextual information of the entities and queries, enabling more accurate and meaningful retrieval. The representation of a given entity and/or query within these embedding spaces is referred to as an embedding (or entity embedding). In an EER-based deep learning model (referred to simply as an EER model), the entity embeddings serve directly as the input feature(s) in the model.

Using entity embeddings as the input feature(s) directly and/or with relevant transformations offers a number of advantages for EER deep learning architectures. In particular, entity embeddings allow these types of models to take advantage of the rich information encoded in the vector representations. Another key use case of entity embeddings is candidate generation or retrieval, especially for entities with fewer relevant candidate recommendations or with a cold-start problem. Unfortunately, there are a few unsolved challenges in designing and implementing EER models at scale.

Two of the main challenges facing EER models are the extremely large quantities of candidate pairs available for the scoring computation and the diversity of available interaction functions between source and destination entity embeddings. As an example, consider a large connections network having 500 million members and 30 million companies. Consider further that it might be desirable to identify the K member-member pairs and/or member-company pairs that are the most similar—that is, those pairs that are relatively closest to one another, within any predetermined threshold distance, in an embedding space. Rigorously determining the top K member-member candidates would require fully calculating the distances between all member-member pairs, for a total of roughly 250,000 trillion member-member distances. Similarly, determining the top K member-company candidates would require determining nearly 15,000 trillion member-company distances. Moreover, the applicable distance measures can vary according to the type of query, meaning that the objective function for a pretrained EER model might be incompatible or suboptimal.

This disclosure introduces the concept of a universal embedding based entity retrieval (EER) deep learning model that leverages candidate reduction and dynamic distance functions to extend the ability of an EER model to score a large quantity of candidates. Moreover, in some embodiments, universal EER models described herein are integrated with an approximate nearest neighbor (ANN) search engine to not only extend the ability of the EER model to score arbitrarily large candidate pools, but also to provide flexible model objectives. In this manner, a universal EER model directly addresses the two main challenges facing EER models.

### DETAILED EMBODIMENT

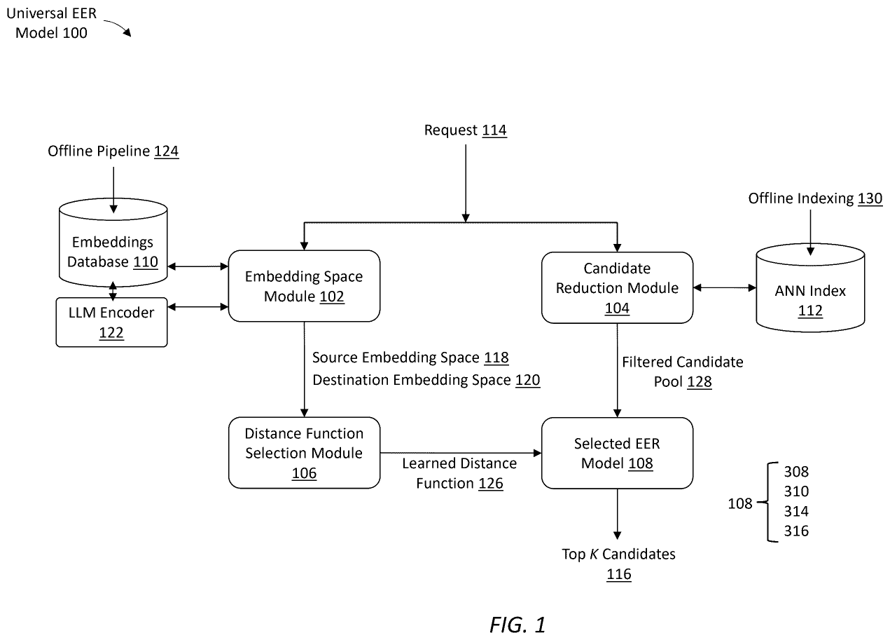

FIG. 1 depicts a block diagram for a universal EER model 100 in accordance with one or more embodiments. As shown in FIG. 1, the universal EER model 100 includes an embedding space module 102, a candidate reduction module 104, a distance function selection module 106, and a selected EER model 108, configured and arranged as shown. In some embodiments, the universal EER model 100 further includes an embeddings database 110. In some embodiments, such as when the candidate reduction module 104 is configured as an approximate nearest neighbor (ANN) search engine, the universal EER model 100 further includes an ANN index 112. The embedding space module 102, candidate reduction module 104, distance function selection module 106, selected EER model 108, embeddings database 110, and/or ANN index 112 can each be stored and/or implemented on cloud, on a client device(s), or on a combination thereof.

In some embodiments, the universal EER model 100 is configured to receive and/or retrieve a request 114. Request 114 is not meant to be particularly limited, and can include, for example, a request for one or more entities and/or entity pairs that satisfy some predetermined condition. In some embodiments, request 114 includes a request for one or more candidate entity pairs, each including a first entity and a second entity. In some embodiments, the first entity is a known and/or predetermined entity common to all candidate entity pairs, sometimes referred to as a source entity, and the second entity in each candidate entity pair is a candidate match for the first entity, sometimes referred to as a destination entity or target entity, according to the predetermined condition. Continuing with the prior example of a connections network, a request 114 might include an ask to provide member and/or company connection recommendations (destination entities) for a given member m (source entity) of the connections network. A request 114 might include an ask for the most applicable adverts to serve as impressions for the member m, or for a list of trade groups having a highest similarity to one or more known characteristics of member m. Additionally or alternatively, in some embodiments, neither the first entity nor the second entity are known and/or predetermined entities. For example, a request 114 might include an ask to provide one or more member pairs that are not currently connected in the network, but which are within some predetermined threshold distance of each other according to a chosen distance measure (or within a first K such pairs which are relatively closest according to the distance measure, etc.). In another example where request 114 need not be limited to any specific single entity (such as member m), request 114 could include more general requests, such as a request to return member-member (or member-company, company-company, member-job impression, etc.) entity pairs having a closest similarity according to a predetermined distance measure in an embedding space. Other request types are possible, and all such configurations are within the contemplated scope of this disclosure.

Observe that each of these requests 114 can be defined as a request to return one or more candidates and/or candidate pairs, also referred to as entity pairs (e.g., Entity 1-Entity 2 pairs), collectively referred to herein as the top K candidates 116 for the request 114. For example, in the case of a request 114 for member connection recommendations, request 114 can be defined as a request to return a list of Entity 1-Entity 2 pairs, where Entity 1 is always member m and Entity 2 is a member connection recommendation for member m (e.g., member a, b, . . . , n). Continuing with this example, the top K candidates 116 might include the K Entity 1-Entity 2 pairs for which Entity 2 is one of the K members, not already connected to member m, having a closest similarity to m (e.g., members having the K closest distances to member m within some embedding space in which members reside). K can be predetermined or dynamically determined based, for example, on a maximum and/or minimum distance threshold. In another example, such as in the case of a generic request 114 for the most similar, currently disconnected members (again, according to any desired distance measure in any desired embedding space), request 114 can be defined as a request to return a list of the K closest Entity 1-Entity 2 pairs, where Entity 1 is some member a and Entity 2 is another member b in the connections network. Of course, these examples are merely illustrative and the top K candidates 116 for request 114 can include any Entity 1-Entity 2 pairs, subject to any desired constraints and/or conditions.

In EER architectures such as the universal EER model 100, entities are represented as vectors (referred to as embeddings) in a continuous vector space (referred to as an embedding space). In some embodiments, each entity (e.g., a person, organization, location, etc.) is mapped to a unique vector in an embedding space. A source embedding space 118 refers to the embedding space where the embeddings of the source entities (or the source component of entity pairs) are located. In the context of retrieval tasks in a connections network, the “source entity” could be the entity for which relevant matches and/or relationships are desired (refer to member m above). For example, if request 114 is a search for related organizations, given a query organization, the query organization's embedding would be in the source embedding space 118. Conversely, a destination embedding space 120 refers to the embedding space where the embeddings of destination entities (or the destination component of entity pairs) are located. In the context of retrieval tasks in a connections network, the “destination entity” could represent the potential matches or related entities to be retrieved based on a provided source entity. For instance, if request 114 is an ask for potential member connections for member m, the potential related members' embeddings would be in the destination embedding space 120.

In some embodiments, the universal EER model 100 and/or the embedding space module 102 leverages a pre-trained large language model (LLM) to generate and understand these embeddings and embedding spaces. More specifically, in some embodiments, the embedding space module 102 includes, is integrated with, and/or is communicatively coupled to a large language model encoder 122 (LLM encoder 122) that is trained specifically to generate embeddings and/or for the task of mapping queries or inputs to their corresponding embedding and/or embedding space.

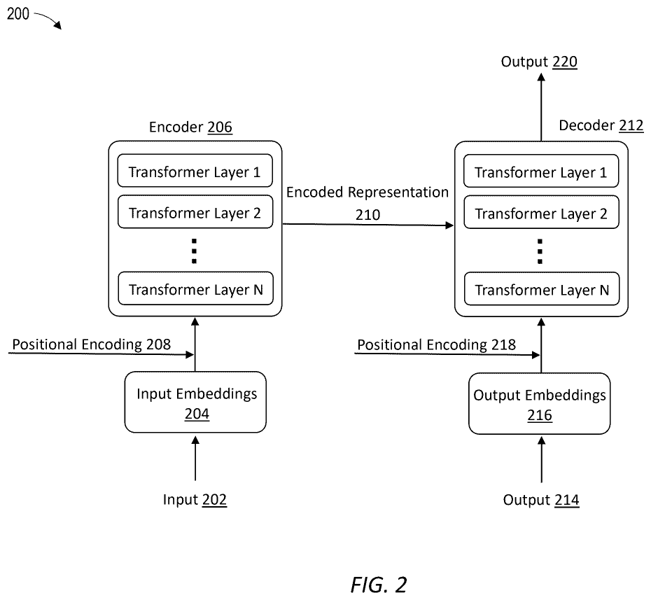

While not meant to be particularly limited, the LLM (refer FIG. 2) and/or LLM encoder 122 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

FIG. 2 illustrates an example transformer-based architecture 200 for a large language model in accordance with one or more embodiments. As shown in FIG. 2, the transformer-based architecture 200 begins with an input 202. The input 202 denotes an input text provided by a user (or upstream system) and can be represented as a sequence of tokens, individual words or sub-words, from which input embeddings 204 can be generated. The input embeddings 204 represent the tokens within the input 202 as numbers, which can be processed using an encoder 206 (e.g., the LLM encoder 122, refer to FIG. 1). In some embodiments, a positional encoding 208 can be generated to encode the position of each token in input 202 as a set of numbers. These numbers can be fed into the encoder 206 with the input embeddings 204, allowing the transformer-based architecture 200 to more effectively understand the order of words in a sentence and to thereby generate grammatically correct and semantically meaningful outputs.

The encoder 206 processes the input embeddings 204 and the positional encoding 208 and generates, for the input 202, an encoded representation 210 that captures the meaning and context of the input 202. To accomplish this, encoder 206 applies a series of self-attention transformer layers (or simply, “transformer layers”), which are a series of hidden states that represent the input 202 at different levels of abstraction. The encoder 206 can include any number of these transformer layers, as desired. The encoded representation 210 is provided to a decoder 212.

The decoder 212 similarly includes a number of transformer layers, as desired, except that the decoder 212 processes an output 214. In most implementations, the output 214 is a right-shifted copy of the input 202, meaning that the decoder 212 can only use the previous words for next-word prediction. In some embodiments, output embeddings 216 can be generated from the output 214 to represent the tokens in the output 214 as numbers, in a similar manner as described with respect to the encoder 206. A positional encoding 218 can be added to the output embeddings 216 to encode the position of each token in output 214 as a set of numbers. The decoder 212 can be trained by minimizing a loss function (also known as an objective function, which quantifies a difference between a predicted output and a known true value) using, for example, gradient descent.

Once trained, the transformer-based architecture 200 can be used during an inference phase to generate an output 220, which can be thought of as a next-word probability (that is, how likely is the next word in the sequence to be x, or y, etc.). In some configurations, the transformer-based architecture 200 includes a linear layer and SoftMax layer (omitted for clarify) to transform a raw output from the decoder 212 into the output 214. For example, after the decoder 212 produces a raw output (e.g., output embeddings), the linear layer can map the output embeddings to a higher-dimensional space, thereby transforming the output embeddings into a same original input space as the input 202. The SoftMax function can be used to generate a probability distribution for each output token in the vocabulary, enabling the transformer-based architecture 200 to generate output tokens with probabilities (e.g., the output 220).

Returning now to FIG. 1, in some embodiments, the embedding space module 102 leverages the LLM encoder 122 and/or the embeddings database 110 to determine a source embedding space 118 and a destination embedding space 120 for the request 114. Continuing with the prior example of a connections network, the source embedding space 118 might be a member embedding space of the connections network and the destination embedding space 120 might be a member embedding space (e.g., member connection recommendations), company embedding space (e.g., high-quality company impressions), advert embedding space (e.g., serving adverts having a highest likelihood of conversion), etc., of the connections network.

In some embodiments, the universal EER model 100 includes an offline pipeline 124 to populate the embeddings database 110 with entity embeddings, such as, for example, member embeddings, company embeddings, etc., of a connections network. In some embodiments, the LLM encoder 122 is leveraged continuously, periodically, and/or intermittently to generate embeddings for predetermined entities (e.g., for members, companies, and/or other entities of a connections network, etc.). In some embodiments, these generated embeddings (not separately indicated) can be stored in the embeddings database 110 for retrieval by the embedding space module 102. In this manner, an example workflow for the universal EER model 100 might include the receiving of a request 114 and, in response, the determination of the source embedding space 118 and the destination embedding space 120 by the LLM encoder 122 (or embedding space module 102) and/or a fetching of the source embedding space 118 and the destination embedding space 120 from the embeddings database 110.

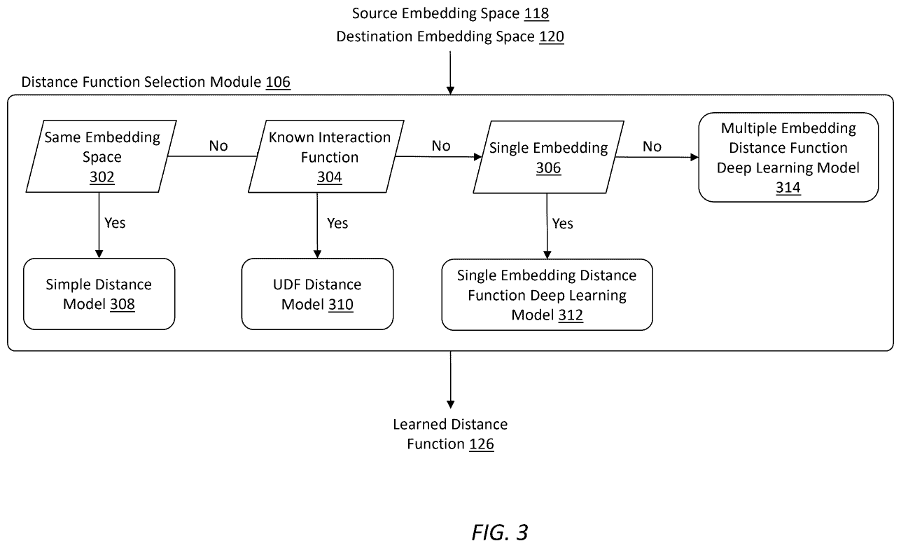

In some embodiments, the source embedding space 118 and the destination embedding space 120 are passed to the distance function selection module 106. In some embodiments, the distance function selection module 106 generates and/or determines, from the source embedding space 118 and the destination embedding space 120, a learned distance function 126. The distance function selection module 106 and the determination of the learned distance function 126 are discussed in greater detail with respect to FIG. 3. In some embodiments, the learned distance function 126 is passed to the selected EER model 108.

In some embodiments, the request 114 is passed to a candidate reduction module 104. Request 114 can be passed to the embedding space module 102 (refer above) and the candidate reduction module 104 simultaneously or concurrently, as desired.

In some embodiments, the candidate reduction module 104 is configured to reduce the number of candidates against which the request 114 is measured, for example, from an initial candidate pool (that is, an exhaustive or full set of all possible candidates) to a reduced candidate pool having fewer candidates than the initial candidate pool. In some embodiments, the remaining candidates after this reduction mechanism define a filtered candidate pool 128. In some embodiments, the filtered candidate pool 128 includes one or more filtered candidates and/or filtered candidate pairs, depending on whether the request 114 is a request for candidates or candidate pairs as described previously.

The candidate reduction module 104 can rely on various techniques to reduce the initial candidate pool. In some embodiments, the candidate reduction module 104 is configured to generate the filtered candidate pool 128 using one or more rules-based candidate knockouts. In these configurations, the candidate reduction module 104 enforces a set of rules or constraints that can be defined and/or predetermined based on the specific requirements of the applicable application domain and/or characteristics of the request 114, source embedding space 118, and/or destination embedding space 120 (e.g., the expected source and/or destination entity corpus).

Rules-based candidate knockouts can be based on various factors, such as entity types, attribute values, relationships, and/or specific conditions derived from the request 114 such as a query context and/or known preferences of the client system or user making the request 114. Rule-based candidate knockouts are particularly useful when there is additional structured information and/or metadata available about the request 114 and/or underlying candidates or entities that can be leveraged to enforce specific criteria for candidate inclusion or exclusion. In some embodiments, the candidate reduction module 104 is configured to extract or retrieve one or more features or metadata for each candidate entity in the initial candidate pool. These features can include entity types, attribute values, relationship information, and/or any other relevant structured data associated with the candidate entities. In some embodiments, the candidate reduction module 104 is configured to apply one or more defined candidate knockout rules to each candidate in the initial candidate pool and, if a candidate entity violates any of the rules or fails to satisfy the specified constraints, that candidate is eliminated from the candidate pool. Continuing with the example of a connections network, a rules-based candidate knockout might be a minimum/maximum activity threshold for network members. For example, the candidate reduction module 104 can remove candidate members that are inactive (as measured against any predetermined activity threshold) from the initial candidate pool of all members of a connections network prior to making member connection recommendations. In this manner, member recommendations are effectively pre-screened to provide recommendations to active members. Other knockout rules are possible, such as, for example, removing companies from an initial company pool according to minimum/maximum company size thresholds and/or removing potential job impressions from an initial job impressions pool according to a comparison of interest metadata tags of each job impression to interest metadata tags of the respective source entity member.

In some embodiments, rules-based candidate knockouts include one or more entity type constraints. For example, if the request 114 and/or requestor (user, upstream system, etc.) preferences indicate that a specific type of entity is required (e.g., only retrieve person entities for a biographical search), entities that do not belong to the specified type can be knocked out. In some embodiments, rules-based candidate knockouts include one or more attribute value constraints which filter entities based on having or not having specific attribute value(s) or ranges. For example, in a product search scenario, entities representing products outside a specified price range and/or not meeting some predetermined criteria (e.g., customer ratings, etc.) could be eliminated. In some embodiments, rules-based candidate knockouts include one or more relationship constraints. For example, in a knowledge graph setting, entities that do not have a specific connection or path to a relevant anchor entity in a query context can be knocked out. In some embodiments, rules-based candidate knockouts include one or more temporal constraints. For example, if the query context of the request 114 involves a specific time period or date range, entities that do not meet the temporal criteria can be eliminated (e.g., retrieve events or news articles within a specific date range satisfying condition X). In some embodiments, rules-based candidate knockouts include one or more geographic constraints which filter entities based on their geographic location and/or proximity to a specified location(s). For example, knockouts can ensure that only restaurants within a certain distance from a source user's current location are retrieved. In some embodiments, rules-based candidate knockouts include one or more hierarchical constraints. For example, in cases where the entities are organized in a hierarchical structure (e.g., a taxonomy or knowledge graph, etc.), pruning constraints can be applied to eliminate entire subtrees or branches of a hierarchy that are deemed less relevant to request 114 based on coarse-grained features or embeddings of the higher-level nodes (e.g., if a higher-level node fails a distance measure threshold for a source entity, any/all subtrees, branches, and/or leaves of the higher-level node can be knocked out). In some embodiments, rules-based candidate knockouts include one or more partitioning and/or sharding constraints. An entity corpus can be partitioned or sharded based on various criteria (e.g., entity types, domains, clustering techniques, etc.), and a request 114 can be routed to only the relevant shards or partitions, reducing the effective search space. In some embodiments, rules-based candidate knockouts include one or more statistical and/or frequency-based constraints which filter entities that are too common or too rare based on a statistical analysis of their occurrence in a dataset. Again, the rules-based candidate knockouts are not meant to be particularly limited and these rules-based candidate knockouts are merely illustrative.

Alternatively, or in addition to the rules-based knockouts, in some embodiments, the candidate reduction module 104 can be configured to generate the filtered candidate pool 128 according to an output from an approximate nearest neighbor (ANN) search engine (not separately indicated). In some embodiments, instead of performing an exhaustive distance calculation between each source and destination entity pair, the candidate reduction module 104 includes and/or leverages the ANN search engine to retrieve the approximate nearest neighbors to the source entity in the respective embedding space, effectively pruning the initial candidate pool to only the most promising entities likely to be included in the top K candidates 116. The nearest neighbor search algorithms employed by the ANN search engine are not meant to be particularly limited, but can include, for example, locality sensitive hashing (LSH), which involves hashing vectors in a way that preserves the distance between them, such as Euclidean LSH, query-aware LSH, and multi-probe LSH, hierarchical navigable small world (HNSW) searching, which is a graph-based technique that constructs a hierarchical navigable small-world graph structure for efficient nearest neighbor searching, randomized partition trees that partition a vector space recursively into smaller cells or regions, such as random projection trees and principal component trees, quantization-based techniques such as product quantization and additive quantization, space partitioning trees such as k-d trees, ball trees, and metric trees, graph-based techniques such as navigating spreading-out graph (NSG), HNSW, and recursive approximate nearest neighbor graphs (RANNG), open-source libraries, such as Annoy, that uses random projections and hierarchical tree-based partitioning, and space partition tree and graph (SPTAG), that combines space partitioning trees and neighborhood graphs for ANN search. In any case, the candidate reduction module 104 includes and/or leverages the ANN search engine to filter the initial candidate pool using one of more nearest neighbor search algorithms to identify a smaller subset of these candidates (the filtered candidate pool 128) that are closer in the identified embedding space to a query representation (e.g., request 114, a source entity, etc.).

In some embodiments, the candidate reduction module 104 is configured to poll (search) an ANN index 112 to retrieve the N-nearest candidates for the request 114. As used herein, the “N-nearest” candidates refers to the N closest candidates to the source entity of the request 114 within an embedding space identified according to the embedding space module 102 and measured according to any predetermined distance measure such as, for example, Euclidean distance, for any predetermined value for N. N need not be a fixed value and the particular distance measure chosen need not be limited. In some embodiments, N is a predetermined maximum threshold according to known compute resources and/or capabilities available to the universal EER model 100. For example, N can be limited to 100 thousand candidates, or 50 thousand candidates, or 1 million candidates, etc., such that the space of remaining candidates in the filtered candidate pool 128 falls within some predetermined range known to be scorable at inference within some predetermine threshold latency and/or time constraint(s). In some embodiments, N is predetermined according to one or more predetermined rules. For example, in the context of member connection recommendations, N can be set to 500,000, or 1 million, etc. most active members of a total member pool of, for example, 4 million members, thereby filtering out a majority of the initial candidates.

In some embodiments, the ANN index 112 can be populated using an offline pipeline (as shown, “offline indexing 130”) in a similar manner as discussed with respect to the offline pipeline 124, except that the ANN index 112 can be built using known indexing systems once a population of embeddings (member embeddings, company embeddings, etc.) is known (via, e.g., the embedding space module 102 as described previously).

The ANN search engine can be initiated from either the source entity side or the destination entity side of the request 114. In some embodiments, such as when the source entity and the destination entity have un-symmetrical sizing and/or complexity, searching from the entity having the relatively lower sizing and/or complexity can reduce the overall search space complexity more effectively (e.g., faster and/or requiring less compute). To illustrate, consider a scenario in which request 114 is looking for a list of member-company connection recommendations in a communications network having 15 million members (source entities) and 800,000 companies (destination entities). In this scenario, initiating an ANN-based candidate filtering scheme from the destination entities will result in a faster, more efficient filtering scheme because the destination entities are naturally related to a much smaller number of candidates.

In some embodiments, the candidate reduction module 104 is configured to generate the filtered candidate pool 128 using a combination of rules-based knockouts and ANN searching. In any case, by employing one or both of these strategies, an initial candidate pool can be significantly reduced before resorting to more computationally expensive tasks, such as when performing distance measurements or relevance calculations between the query embeddings and/or entity embeddings. In some embodiments, the filtered candidate pool 128 is passed to a selected EER model 108.

As discussed previously, in some embodiments, the learned distance function 126 and the filtered candidate pool 128 are passed to the selected EER model 108. In some embodiments, the selected EER model 108 generates top K candidates 116 for the request 114 using the learned distance function 126 and the filtered candidate pool 128. In some embodiments, the selected EER model 108 determines a distance between each candidate pair in the filtered candidate pool 128 using the learned distance function 126. Notably, the selected EER model 108 can explore a complete and/or exhaustive scoring of all candidates in the filtered candidate pool 128, thereby providing a so-called modified brute force (MBF) EER architecture. As used herein, a “modified” brute force architecture refers to a model architecture that exhaustively scores all of the candidates which remain after reducing the candidate pool (that is, after the full candidate pool has been filtered via the candidate reduction module 104 as described previously), in contrast to a conventional brute force architecture which exhaustively checks the complete, initial space of candidates against request 114. In some embodiments, the selected EER model 108 is a model selected according to the distance function selection module 106.

FIG. 3 depicts a block diagram for the distance function selection module 106 (refer to FIG. 1) in accordance with one or more embodiments. As shown in FIG. 3, the distance function selection module 106 receives the source embedding space 118 and the destination embedding space 120. In some embodiments, the distance function selection module 106 is trained to select the learned distance function 126 according to a comparison of the source embedding space 118 to the destination embedding space 120. In some embodiments, the distance function selection module 106 selects a model (the selected EER model 108, refer to FIG. 1) according to the comparison of the source embedding space 118 to the destination embedding space 120. In some embodiments, the distance function selection module 106 selects, for the learned distance function 126, a distance function from a collection of available distance functions. In some embodiments, the selected distance function is a least complex distance function given the source embedding space 118 and destination embedding space 120 for a particular application. The selection of the learned distance function 126 for a given input of a source embedding space 118 and a destination embedding space 120 is discussed in further detail below with respect to a number of possible distance functions and distance function models. Advantageously, configuring the distance function selection module 106 to learn to select a learned distance function 126 in this manner enables the universal EER model 100 to dynamically handle arbitrary combinations of source and destination embedding spaces.

In some embodiments, the comparison of the source embedding space 118 to the destination embedding space 120 is a multi-parameter comparison including a progressive sequence of comparison steps. In some embodiments, the comparison steps include a first comparison step 302, a second comparison step 304, and a third comparison step 306.

In some embodiments, the first comparison step 302 includes determining whether the source embedding space 118 and the destination embedding space 120 are the same embedding space (that is, whether they are of the same embedding type and/or within a same vector space). For example, if request 114 involves a request for member connection recommendations for some member m of a connections network (that is, a request 114 requiring member-to-member comparisons), the first comparison step 302 will evaluate to “true” or “yes”, if source and destination members will lie within a same member embedding space. Conversely, for example, if request 114 involves a request for company connection recommendations for some member m of a connections network (that is, a request 114 requiring member-to-company comparisons), the first comparison step 302 will evaluate to “false” or “no”, if source and destination members will lie within different embeddings spaces (e.g., members might lie in a member embedding space and companies might lie in a company embedding space). Note that these examples are merely illustrative of the concept. In some embodiments, different entity types do not necessarily belong to different vector spaces. For example, a member embedding might be derived from a profile description containing text data and/or text data in posts made by the member. Similarly, a company embedding might be derived from a company profile containing text data and/or text data in posts made by the company. In this scenario, both member embeddings and company embeddings, while different entity types (member vs. company), might be derived from a same text embedding space, such as the learned text embedding space of a pre-trained large language model (e.g., GPT, etc.). In another example, member entities might be derived using skill names in a profile, and an article entity (or post entity, etc.) might also be derived using skills. If this scenario, both members and article/post entities, derived from a same embedding model, will lie within a same embedding space.

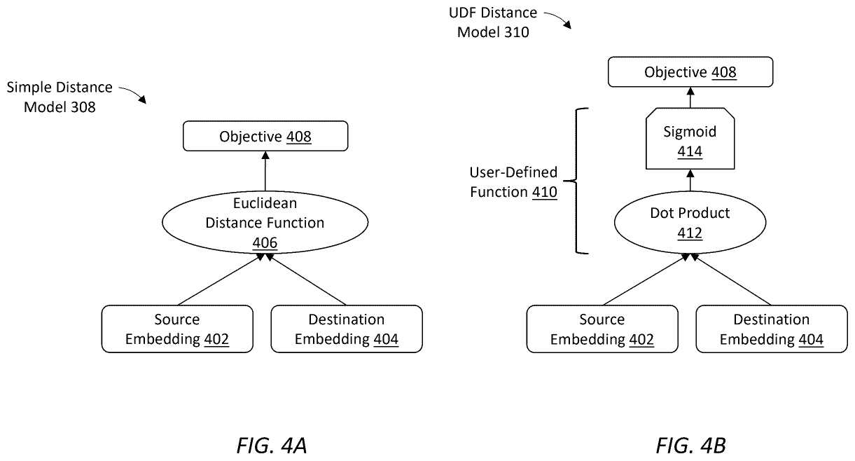

In some embodiments, if the first comparison step 302 evaluates to “yes”, the distance function selection module 106 selects a simple distance model 308 for the learned distance function 126. As used herein, a “simple” distance model refers to a model which determines distances using intra-embedding space distance measures, such as, for example, Euclidean distance, L2 distance, and cosine similarity. Advantageously, intra-embedding space distance measures are relatively fast to compute and the first comparison step 302 ensures that distances can be computed using intra-embedding type distance measures when possible (that is, when source and destination are within a same embedding space). An example simple distance model 308 is shown in FIG. 4A.

Alternatively, if the first comparison step 302 evaluates to “no”, the distance function selection module 106 proceeds to the second comparison step 304. In some embodiments, the second comparison step 304 includes determining whether the underlying interaction function between the source embedding space 118 and the destination embedding space 120 is known. As discussed previously, interaction functions can vary depending on the type of comparisons and entities associated with request 114. In some embodiments, the underlying interaction function is the known embedding interaction/combining layer used by the embedding space module 102 and/or LLM encoder 122 (refer to FIG. 1) for generating the source embedding space 118 and destination embedding space 120.

In these scenarios, the second comparison step 304 evaluates to “yes”, and the distance function selection module 106 selects a predetermined user-defined function (UDF) distance model 310 for the learned distance function 126. In some embodiments, the distance function selection module 106 stores and/or retrieves a plurality of UDF distance models, and the selection of the predetermined UDF distance model 310 is the selection of one of the stored and/or retrieved UDF distance models having an interaction layer that matches the embedding interaction layer used when generating the source embedding space 118 and destination embedding space 120. To support this task, in some embodiments, the distance function selection module 106 stores and/or retrieves a plurality of UDF distance models having a range of predetermined interaction layer types. For example, the plurality of UDF distance models can include distance models that rely on a dot product function within the interaction layer(s), similarity and concatenation of vector pairs, a hybrid of dot product and neural network structures, convolutional neural networks to extract local patterns and dependencies within the embeddings, element-wise operations, such as element-wise multiplication, addition, or more complex functions, attention mechanisms that dynamically assign importance weights to different parts of the respective embeddings, bilinear interactions, which involve computing a weighted sum of the outer products between pairs of vectors from different embeddings, and/or recurrent layers such as long short-term memory (LSTM) or gated recurrent unit (GRU) interaction layers. Advantageously, leveraging a UDF distance model 310 having a matching interaction layer to that already used for the source embedding space 118 and destination embedding space 120 ensures that the resulting distance calculations will be as efficient as possible, considering, in particular, that UDF distance model 310 is only selected in scenarios where the embeddings spaces are different and the (relatively less complex) simple distance measures are not possible/applicable. An example UDF distance model 310 is shown in FIG. 4B.

Alternatively, if the second comparison step 304 evaluates to “no”, the distance function selection module 106 proceeds to the third comparison step 306. As discussed previously, different embedding learning designs encode different entity network and entity properties and interactions into vector representations. For many use cases, the objectives of the underlying embedding models and entity/candidate retrievals are not identical or even distinguished from each other. In those scenarios, an overall closest distance as measured using an intra-embedding space measure such as Euclidean distances (refer to simple distance model 308) or using an inter-embedding space measures such as UDF distances (refer to UDF distance model 310) might be undefined, or might not provide a sufficient level of approximation for candidate generation according to any desired threshold level of approximation accuracy. To solve this problem, the distance function selection module 106 can leverage deep learning structures to learn a distance function by treating the embeddings as input features.

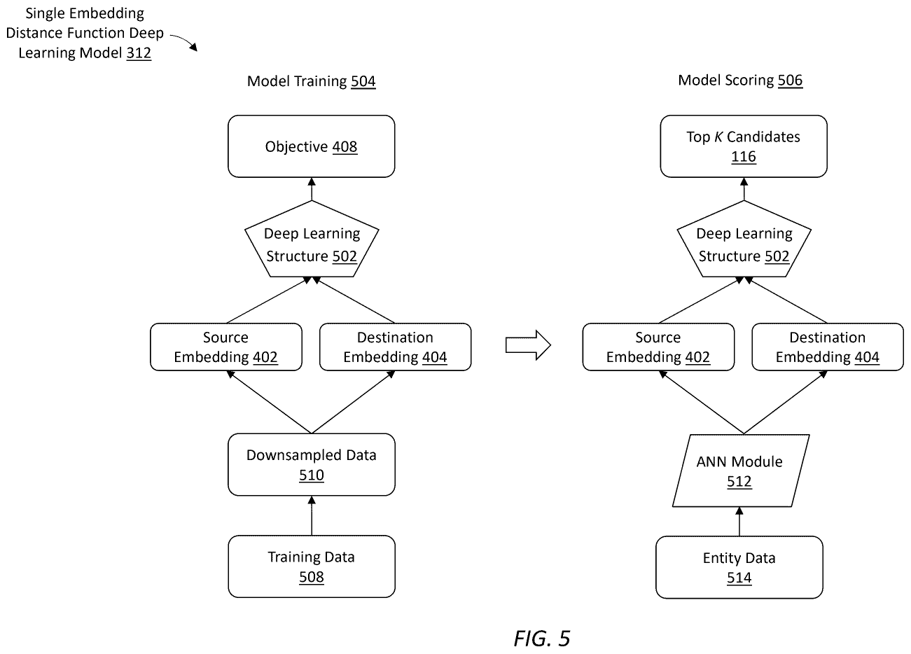

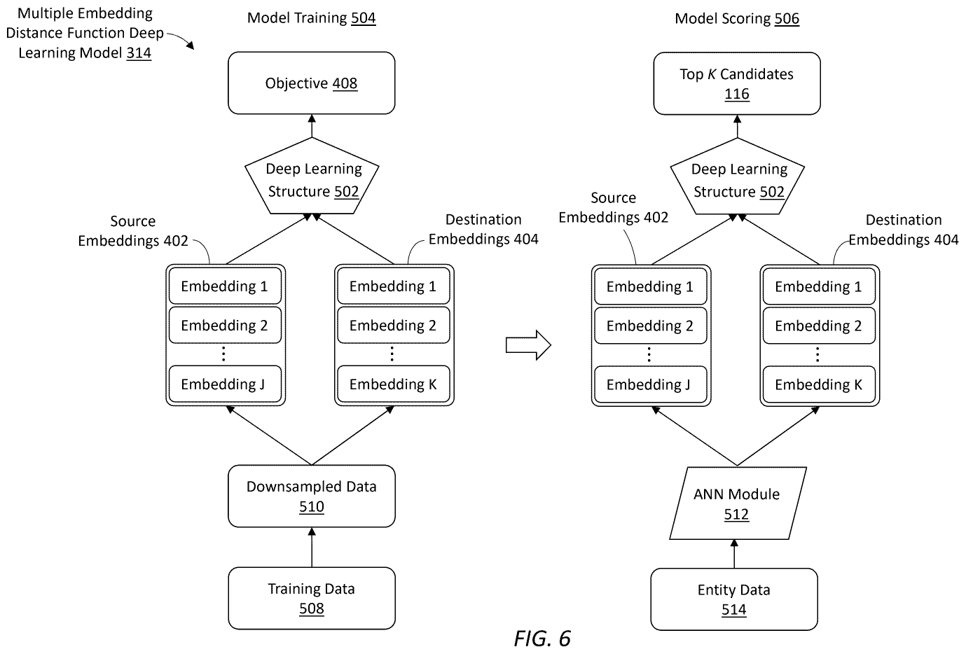

In some embodiments, the third comparison step 306 includes determining whether source embeddings and destinations embeddings for request 114 are, respectively, of a single embedding type. In some embodiments, if the third comparison step 306 evaluates to “yes”, the distance function selection module 106 selects a single embedding distance function deep learning model 312 for the learned distance function 126. The single embedding distance function deep learning model 312 is discussed in greater detail with respect to FIG. 5. Alternatively, if the third comparison step 306 evaluates to “no”, the distance function selection module 106 selects a multiple embedding distance function deep learning model 314 for the learned distance function 126. The multiple embedding distance function deep learning model 314 is discussed in greater detail with respect to FIG. 6.

FIG. 4A depicts a block diagram for an example simple distance model 308 (refer to FIG. 3) in accordance with one or more embodiments. As shown in FIG. 4A, the simple distance model 308 can include a single source embedding 402 and a single destination embedding 404 in a same embedding space (due to application of the first comparison step 302). In some embodiments, the source embedding 402 and the destination embedding 404 are compared using an intra-embedding distance measure such as the Euclidean distance function 406 (as shown). In some embodiments, an objective 408 (also referred to as an objective function) is defined to seek those source-destination pairs having the shortest distances according to the Euclidean distance function 406 (that is, those candidate pairs which minimize objective 408).

FIG. 4B depicts a block diagram for an example UDF distance model 310 (refer to FIG. 3) in accordance with one or more embodiments. As shown in FIG. 4B, the UDF distance model 310 can include a single source embedding 402 and a single destination embedding 404 in different embedding spaces but having a known interaction function (due to application of the first comparison step 302 and the second comparison step 304). In some embodiments, the source embedding 402 and the destination embedding 404 are compared using a predefined user-defined function 410 (that is, an inter-embedding distance measure) that matches the known interaction function, such as, for example, dot product 412 and sigmoid 414 (as shown). In some embodiments, an objective 408 is defined to minimize (or maximize) the user-defined function 410. For example, in some embodiments, the UDF distance model 310 seeks to find those source-destination pairs which provide outputs from sigmoid 414 having a smallest (or largest) value (or the K source-destination pairs having the K smallest distances, for any predetermined value for K). The objective 408 is not meant to be particularly limited. In some embodiments, the objective 408 is to minimize the respective inter-embedding distance measure, which can be determined as 1/sigmoid 414 (input), where the input includes the learned weights and dot product 412 for source embedding 402 and destination embedding 404. In some embodiments, the objective 408 is an interaction probability (refer to the denominator of Equation (1) below). In some embodiments, a larger interaction probability indicates a better the candidate. In some embodiments, depending on the chosen objective 408 (e.g., a 1/sigmoid (input) transformation, etc.), the interaction probability can be transformed to a distance, where smaller distances indicate better candidates.

FIG. 5 depicts a block diagram for an example single embedding distance function deep learning model 312 (refer to FIG. 3) in accordance with one or more embodiments. As shown in FIG. 5, the single embedding distance function deep learning model 312 can include a single source embedding 402 and a single destination embedding 404 in different embedding spaces, each embedded via an unknown interaction function (due to application of the first comparison step 302, the second comparison step 304, and the third comparison step 306).

In some embodiments, the single embedding distance function deep learning model 312 includes a deep learning structure 502 that can learn, during model training 504 (also referred to as a training phase), distance functions. In some embodiments, deep learning structure 502 uses the source embedding 402 and the destination embedding 404 as input features when learning the distance function. In some embodiments, the learned distance function can then be leveraged when determining, during later model scoring 506 (also referred to as an inference phase) a distance between a source embedding 402 and a destination embedding 404.

Advantageously, the deep learning structure 502 can learn distance functions using any desired embeddings as input features. In some embodiments, the deep learning structure 502 can learn distance functions according to the following equation (1):

$$Distance ( x ) = 1 / p ( interaction \vert entity embeddings ) \qquad ( 1 )$$

where the Distance (x) indicates a distance between the source and destination embeddings in terms of an interaction probability for an interaction in a specific time window and x is the embedding feature, which could include multiple embeddings. In some embodiments, the time window can be selected according to any predetermined metrics, such as, for example, a known context of the source embeddings and/or destination embeddings.

To illustrate, consider a scenario in which model training 504 involves member embeddings—the time window might be set using predetermined rules, network knowledge, and/or known project details or constraints to ensure that each member (or a threshold number of members) will have enough activity data for training according to any desired threshold. In other words, a time window of 7 days, or 28 days, etc. can be set depending on characteristics of the request 114, source embedding 402, and/or destination embedding 404. For example, existing network knowledge might include metrics that members interact, on average, once every 48 hours. In that scenario, the time window might be set to 48 hours to allow, on average, each member to have at least one data point of activity for training. Alternatively, or in addition, the time window might be set at some multiple of 48 hours to allow for any desired number of average interactions. In some embodiments, the interaction can be defined according to one or more known objectives. For example, in a scenario in which it is desired to increase member engagement with email impressions, the interaction could be the member clicks on the emails.

Advantageously, configuring the deep learning structure 502 to learn distance functions using any desired/arbitrary embeddings as input features in this manner allows the deep learning structure 502 (and, at increasing levels of model abstraction, the underlying single embedding distance function deep learning model 312, distance function selection module 106, and universal EER model 100) to be decoupled from the upstream model design. In short, by providing a way to learn distance functions from arbitrary input embeddings, details regarding any upstream model (e.g., some upstream model responsible for sourcing/generating the embeddings, etc.) and/or how that model might be trained are not needed. This is an advantage in any scenario where the upstream model design and/or training data and/or training methodology are unknown. In short, by providing a way to learn distance functions from arbitrary input embeddings, if a new embedding is provided, the single embedding distance function deep learning model 312 will be able to learn the applicable distance function. This can be especially helpful when multiple embeddings are available (refer to FIG. 6), as multiple embeddings can be leveraged simultaneously to retrain the respective model when learning a distance function. Additionally, configuring the single embedding distance function deep learning model 312 to learn distance functions from arbitrary embeddings obviates the need to retrain such a model in response to a change in objective 408. In short, so long as the same embeddings are used, the single embedding distance function deep learning model 312 can learn the applicable distance function for any objective 408 (that is, such learning is natively decoupled from any particular selection of an objective 408).

In some embodiments, deep learning structure 502 is trained using training data 508. In some embodiments, the training data 508 includes positive training data and negative training data. Positive training labels represent instances or examples that belong to a desired class or category that the deep learning structure 502 is learning to identify or recommend. Continuing with the context of a connections network, positive training labels could be, for example, pairs of members who are already connected and/or have established a connection within the designated time window when the training task is to make member recommendations. In another example, such as when recommending posts, articles, and/or other content to members, positive training labels could include member-content pairs where the member has engaged with or expressed interest in that particular content (e.g., liked the content, shared the content, commented on the content, etc.). In yet another example, such as when predicting a member's interests or preferences when choosing company and/or advert impressions, positive training labels could be member-interest pairs where the member has explicitly indicated their interest in a particular topic, activity, and/or group of the connections network (or any other available data source). In still another example, such as tasks involving the detection of sentiment, positive training labels would be text instances in posts, comments, etc. that express a positive sentiment or emotion (sentiment can be understood using, for example, the LLM encoder 122 of FIG. 1 and/or underlying LLM 200 of FIG. 2). Conversely, negative training labels represent instances or examples that do not belong to a desired class or category that the deep learning structure 502 is learning to identify or avoid. Continuing with the context of a connections network, negative training labels could be, for example, pairs of members who do not establish a connection within the designated time window after a member recommendation to connect has been impressed to either or both members. Other negative training labels could be member-content pairs with no member engagement, member-interest pairs with no expressed indications that the member shares the interest, and text instances in posts, comments, etc. that express a negative sentiment or emotion.

In some embodiments, the training data 508 is downsampled to reduce the size of the training data 508. The remaining data can be referred to as downsampled data 510. In some embodiments, the training data 508 is downsampled using knockouts and/or ANNs in a similar manner as described with respect to the candidate reduction module 104 (refer to FIG. 1), thereby allowing the downsampled data 510 to retain only the most application training data. In some embodiments, the training data 508 is downsampled to reduce the size of one of the positive labels or negative labels of training data 508. Such a configuration can be particularly useful in scenarios where the size of the positive labels or negative labels is asymmetrical. For example, in connection networks the amount of member-member positive label pairs is far exceeded by the number of member-member negative label pairs. In short, the number of actual member connections is far exceeded (by several orders of magnitude) by the size of all possible member connections. In some embodiments, the source embedding 402 and/or destination embedding 404 can be sourced from the downsampled data 510.

Similarly, in some embodiments, model scoring 506 can leverage an ANN module 512 (refer to discussion of ANN models and indices described previously with respect to FIG. 1) to reduce an initial set of entity data 514. In some embodiments, the source embedding 402 and/or destination embedding 404 can be sourced from the entity data 514 after filtering via the ANN module 512. In this manner, deep learning structure 502 can efficiently generate, during model scoring 506, top K candidates 116 for request 114 (refer to FIG. 1). Candidate filtering performed via the ANN module 512 enables an efficient identification of relevant entities for candidate retrieval from the complete set of entity data 512. Advantageously, ANN-based candidate filtering allows for a brute force comparison of all remaining candidates, thus enabling the single embedding distance function deep learning model 312 to function as a so-called modified brute force EER architecture as described previously. Moreover, in some embodiments, candidate filtering performed via the ANN module 512 can be sufficient, based on the underlying data, to enable model scoring 506 to occur offline (that is, to enable offline scoring). In other words, the ANN module 512 can enable model scoring 506 to be performed at a faster cadence that would be possible using a true brute force scoring over the entire set of entity data 514. For example, offline scoring might occur at a daily occurrence for datasets which might require, for full brute force architectures, weeks or even months to score. The ANN module 512 offers other advantages as well. For example, in some embodiments, candidate filtering performed via the ANN module 512 can enable the identification of relevant (according to any desired metric, such as a distance measure, semantic similarity, etc.) recommendations, even for entities with low liquidity (that is, entities with very little preexisting data for analysis) and/or cold-start entities (that is, new entities with no preexisting data and/or only trivial data such as the labeling itself of the entity when generated).

FIG. 6 depicts a block diagram for an example multiple embedding distance function deep learning model 314 (refer to FIG. 3) in accordance with one or more embodiments. As shown in FIG. 6, the multiple embedding distance function deep learning model 314 can be configured in a similar manner as the single embedding distance function deep learning model 312 (refer to FIG. 5), except that the multiple embedding distance function deep learning model 314 can include a plurality of source embeddings 602 (e.g., Embedding 1, Embedding 2, . . . , Embedding J) and a plurality of destination embeddings 404 (e.g., Embedding 1, Embedding 2, . . . , Embedding K) for any values J and K. The embedding sizes J and K for the source embeddings 402 and the destination embeddings 404, respectively, can be the same, but need not be. In short, the multiple embedding distance function deep learning model 314 proposes an architecture for a learnable distance function which is considering not only the context of each use case, but which is also able to adopt different and multiple embeddings for the task. Notably, different embedding types (also referred to as embedding designs) offer different properties of the respective source and destination entities.

Advantageously, leveraging multiple input embeddings in this manner when training the deep learning structure 502 enables more varied and complex candidate neighborhoods and contexts, ultimately resulting in a more accurate model scoring 506. Moreover, configuring the deep learning structure 502 to learn distance functions using any desired/arbitrary embeddings as input features in this manner allows the deep learning structure 502 (and, at increasing levels of model abstraction, the underlying multiple embedding distance function deep learning model 314, distance function selection module 106, and universal EER model 100) to be decoupled from the upstream model design, in a similar manner as discussed with respect to FIG. 5. In addition, unlike the single embedding distance function deep learning model 312, the multiple embedding distance function deep learning model 314 can leverage any number of embeddings (e.g., two or more, 5, 10, etc.) for each of the source embeddings 402 and the destination embeddings 404, allowing such a system to use all (or a relatively wider breadth) of available embedding data when learning distance functions. This directly contributes to increased inference accuracy. The tradeoff is increased model complexity, and, in some scenarios, higher latencies during model scoring 506. However, observe that the multiple embedding distance function deep learning model 314 is only called when the third comparison step 306 evaluates to “no”, meaning that the relatively less complex single embedding distance function deep learning model 312 is leveraged when possible (that is, when only a single embedding type is involved and/or available for each of the source embedding 402 and destination embedding 404). Thus, the increased accuracy of the multiple embedding distance function deep learning model 314, and accompanying increase in model complexity and inference latency, is only realized in the specific scenarios where multiple embedding types are involved and/or available. Similarly, the single embedding distance function deep learning model 312 itself is only called when the second comparison step 304 evaluates to “yes”, meaning that the still more relatively less complex simple distance model 308 and UDF distance model 310 can be relied upon in scenarios in which they are applicable.

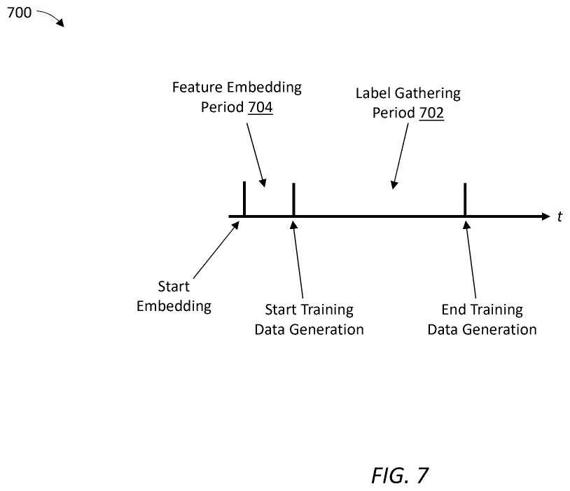

FIG. 7 depicts a block diagram for an example embedding feature period and label period design 700 in accordance with one or more embodiments. In some embodiments, a model objective (e.g., objective 408 in FIGS. 5 and 6) is defined by an interaction between entities in a label gathering period 702. In some embodiments, the label gathering period 702 is separated from a feature embedding period 704 to avoid information leakage. Information leakage refers to the unintentional inclusion of data and/or signals in training data that provides information about target labels and/or predictions, allowing a model to learn shortcuts and/or spurious correlations rather than the intended underlying patterns and relationships. Information leakage can occur, for example, when the process of gathering or generating training labels inadvertently introduces information that should not be available to the model during the scoring or inference phase. Separating the label gathering period 702 from the feature embedding period 704 can allow a model to avoid and/or mitigate information leakage. In short, a separation between these periods aims to ensure that information used to generate labels is not present in the data used to create feature embeddings or representations.

In some embodiments, during feature embedding period 704, raw data (e.g., text, images, user interactions, etc.) are processed, and feature embeddings or representations are generated. Notably, these embeddings capture relevant information and patterns from the raw data but do not include any information related to target labels or predictions. Then, during labeling gathering period 702, labels and/or target values for the training data are gathered and/or generated. Label gathering can involve human and/or system generated annotations and can include data derived from future events or activities with respect to the feature embedding period 704 (that is, data from events that occur after the feature embedding period 704).

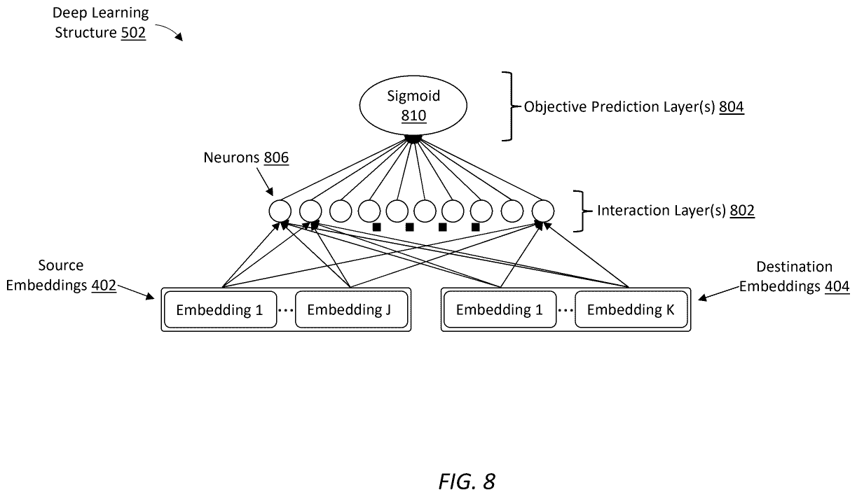

FIG. 8 depicts a block diagram for an example deep learning structure 502 (refer to FIGS. 5 and 6) in accordance with one or more embodiments. In some embodiments, the deep learning structure 502 includes two distinct modules: namely, interaction layer(s) 802 and objective predictive layer(s) 804. In some embodiments, the interaction layer 802 includes 1 or 2 layers of fully connected neural networks, although a greater number of layers is possible and within the contemplated scope of this disclosure. In some embodiments, each interaction layer 802 includes one or more neurons 806, for example, 10 to 20 neurons, although more or fewer neurons are possible and within the contemplated scope of this disclosure. In some embodiments, the number of layers and number of neurons in each layer are selected to minimize computational complexity subject to any predetermined prediction accuracy. That is, the interaction layers 802 can include the smallest neural network design which satisfies the predetermined prediction accuracy. In some embodiments, the objective prediction layer 804 relies on a single neuron, such as a sigmoid function neuron 810, to predict the interaction probability. Of course, the sigmoid function neuron 810 is merely illustrative and the single neuron can target any desired objective, such as any described previously.

Advantageously, structuring the deep learning structure 502 in this manner allows for the deep learning structure 502 to be trained to identify so-called “good” candidates, that is, the top K candidates, instead of focusing on determining an accurate ranking order between those top K candidates. The deep learning structure 502 distinguishes the simple embedding distance function deep learning model 314 and the multiple embedding distance function deep learning model 314, which rely upon the deep learning structure 502, from prior first-pass ranker (FPR) models, second-pass ranker models, and affinity models. In short, observe that the deep learning structure 502 does not need pair features, which are typically the most powerful features relied on by these types of models, but which make feature joins expansive and, due to trillions of potential entity pairs, practically impossible or at least infeasible. This is possible, again, because the deep learning structure 502 can be trained to seek the top K candidates without regard for their respective ranking order.

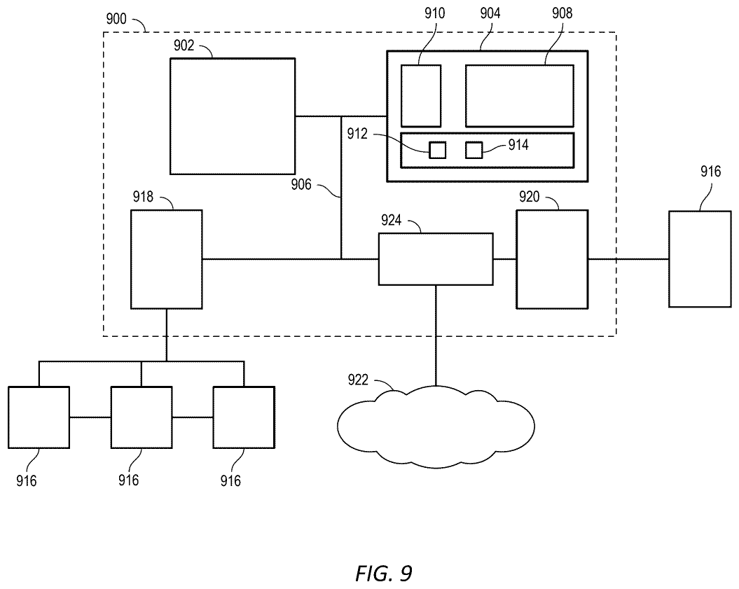

FIG. 9 illustrates aspects of an embodiment of a computer system 900 that can perform various aspects of embodiments described herein. In some embodiments, the computer system(s) 900 can implement and/or otherwise be incorporated within or in combination with the universal EER model 100 (refer to FIG. 1), the distance function selection module 106 (refer to FIG. 3), and/or the underlying selected EER model 108 (e.g., simple distance model 308, single embedding distance function deep learning model 312, etc.). In some embodiments, a computer system 900 can be implemented server-side. For example, a remote computer system 900 can be configured to receive a request (e.g., request 114, such as a request for member connection recommendations, and in response, to respond with the top K candidates 116 for the request 114.

The computer system 900 includes at least one processing device 902, which generally includes one or more processors or processing units for performing a variety of functions, such as, for example, completing any portion of the universal EER model 100 described previously. Components of the computer system 900 also include a system memory 904, and a bus 906 that couples various system components including the system memory 904 to the processing device 902. The system memory 904 may include a variety of computer system readable media. Such media can be any available media that is accessible by the processing device 902, and includes both volatile and non-volatile media, and removable and non-removable media. For example, the system memory 904 includes a non-volatile memory 908 such as a hard drive, and may also include a volatile memory 910, such as random access memory (RAM) and/or cache memory. The computer system 900 can further include other removable/non-removable, volatile/non-volatile computer system storage media.

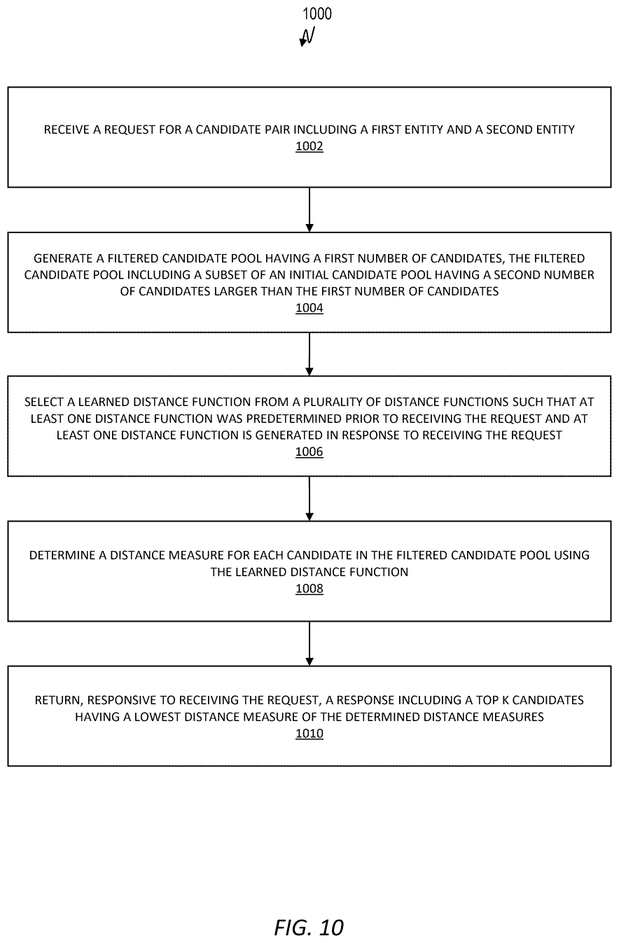

The system memory 904 can include at least one program product having a set (e.g., at least one) of program modules that are configured to carry out functions of the embodiments described herein. For example, the system memory 904 stores various program modules that generally carry out the functions and/or methodologies of embodiments described herein. A module or modules 912, 914 may be included to perform functions related to the block diagrams described with respect to FIG. 10. The computer system 900 is not so limited, as other modules may be included depending on the desired functionality of the computer system 900. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 902 can also be configured to communicate with one or more external devices 916 such as, for example, a keyboard, a pointing device, and/or any devices (e.g., a network card, a modem, etc.) that enable the processing device 902 to communicate with one or more other computing devices. Communication with various devices can occur via Input/Output (I/O) interfaces 918 and 920.

The processing device 902 may also communicate with one or more networks 922 such as a local area network (LAN), a general wide area network (WAN), a bus network and/or a public network (e.g., the Internet) via a network adapter 924. In some embodiments, the network adapter 924 is or includes an optical network adaptor for communication over an optical network. It should be understood that although not shown, other hardware and/or software components may be used in conjunction with the computer system 900. Examples include, but are not limited to, microcode, device drivers, redundant processing units, external disk drive arrays, RAID systems, and data archival storage systems, etc.

Referring now to FIG. 10, a flowchart 1000 for leveraging a universal embedding based entity retrieval deep learning model is generally shown according to an embodiment. The flowchart 1000 is described with reference to FIGS. 1 to 9 and may include additional steps not depicted in FIG. 10. Although depicted in a particular order, the blocks depicted in FIG. 10 can be, in some embodiments, rearranged, subdivided, and/or combined.

At block 1002, the method includes receiving a request for a candidate pair having a first entity and a second entity.

At block 1004, the method includes generating a filtered candidate pool having a first number of candidates. In some embodiments, the filtered candidate pool includes a subset of an initial candidate pool having a second number of candidates larger than the first number of candidates.

At block 1006, the method includes selecting a learned distance function from a plurality of distance functions. In some embodiments, at least one distance function was predetermined prior to receiving the request and at least one distance function is generated in response to receiving the request. In some embodiments, selecting a learned distance function from a plurality of distance functions includes determining a source embedding space for the first entity and a destination embedding space for the second entity.

At block 1008, the method includes determining a distance measure for each candidate in the filtered candidate pool using the learned distance function.

At block 1010, the method includes returning, responsive to receiving the request, a response comprising a top K candidates having lowest distances measure of the determined distance measures.

In some embodiments, such as when the source embedding space and the destination embedding space are a same embedding space, the learned distance function is an intra-embedding space distance measure that is predetermined prior to receiving the request.

In some embodiments, such as when the source embedding space and the destination embedding space are different embedding spaces having a known interaction function, the learned distance function comprises an inter-embedding space distance measure that is predetermined prior to receiving the request. In some embodiments, the inter-embedding space distance measure is a same interaction function as the known interaction function.

In some embodiments, such as when the source embedding space and the destination embedding space are difference embedding spaces having an unknown interaction function, the learned distance function is determined using one of a single embedding distance function deep learning model and a multiple embedding distance function deep learning model. In some embodiments, the single embedding distance function deep learning model is selected to determine the learned distance function model when the source embedding space and the destination embedding space are, respectively, of a single embedding type. In some embodiments, the multiple embedding distance function deep learning model is selected to determine the learned distance function model when the source embedding space and the destination embedding space include, respectively, two or more embedding types.

In some embodiments, generating the filtered candidate pool includes applying one or more of a rules-based candidate knockout or an ANN search to the initial candidate pool.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
receiving a request for a candidate pair comprising a first entity and a second entity;
generating a filtered candidate pool comprising a first number of candidates, the filtered candidate pool comprising a subset of an initial candidate pool comprising a second number of candidates larger than the first number of candidates;
selecting a learned distance function from a plurality of distance functions, wherein at least one distance function was predetermined prior to receiving the request and at least one distance function is generated in response to receiving the request;
determining a distance measure for each candidate in the filtered candidate pool using the learned distance function; and
returning, responsive to receiving the request, a response comprising a top K candidates having a lowest distance measure of the determined distance measures.

2. The method of claim 1, wherein selecting a learned distance function from a plurality of distance functions comprises determining a source embedding space for the first entity and a destination embedding space for the second entity.

3. The method of claim 2, wherein, when the source embedding space and the destination embedding space are a same embedding space, the learned distance function comprises an intra-embedding space distance measure that is predetermined prior to receiving the request.

4. The method of claim 2, wherein, when the source embedding space and the destination embedding space are different embedding spaces having a known interaction function, the learned distance function comprises an inter-embedding space distance measure that is predetermined prior to receiving the request.

5. The method of claim 4, wherein the inter-embedding space distance measure comprises a same interaction function as the known interaction function.

6. The method of claim 2, wherein, when the source embedding space and the destination embedding space are difference embedding spaces having an unknown interaction function, the learned distance function is determined using one of a single embedding distance function deep learning model and a multiple embedding distance function deep learning model.

7. The method of claim 6, wherein the single embedding distance function deep learning model is selected to determine the learned distance function model when the source embedding space and the destination embedding space are, respectively, of a single embedding type.

8. The method of claim 6, wherein the multiple embedding distance function deep learning model is selected to determine the learned distance function model when the source embedding space and the destination embedding space include, respectively, two or more embedding types.

9. The method of claim 1, wherein generating the filtered candidate pool comprises applying one or more of a rules-based candidate knockout or an approximate nearest neighbor (ANN) search to the initial candidate pool.

10. A system having a memory, computer readable instructions, and one or more processors for executing the computer readable instructions, the computer readable instructions controlling the one or more processors to perform operations comprising:
receiving a request for a candidate pair comprising a first entity and a second entity;
generating a filtered candidate pool comprising a first number of candidates, the filtered candidate pool comprising a subset of an initial candidate pool comprising a second number of candidates larger than the first number of candidates;
selecting a learned distance function from a plurality of distance functions, wherein at least one distance function was predetermined prior to receiving the request and at least one distance function is generated in response to receiving the request;
determining a distance measure for each candidate in the filtered candidate pool using the learned distance function; and
returning, responsive to receiving the request, a response comprising a top K candidates having a lowest distance measure of the determined distance measures.

11. The system of claim 10, wherein selecting a learned distance function from a plurality of distance functions comprises determining a source embedding space for the first entity and a destination embedding space for the second entity.

12. The system of claim 11, wherein, when the source embedding space and the destination embedding space are a same embedding space, the learned distance function comprises an intra-embedding space distance measure that is predetermined prior to receiving the request.

13. The system of claim 11, wherein, when the source embedding space and the destination embedding space are different embedding spaces having a known interaction function, the learned distance function comprises an inter-embedding space distance measure that is predetermined prior to receiving the request.

14. The system of claim 13, wherein the inter-embedding space distance measure comprises a same interaction function as the known interaction function.

15. The system of claim 11, wherein, when the source embedding space and the destination embedding space are difference embedding spaces having an unknown interaction function, the learned distance function is determined using one of a single embedding distance function deep learning model and a multiple embedding distance function deep learning model.

16. The system of claim 15, wherein the single embedding distance function deep learning model is selected to determine the learned distance function model when the source embedding space and the destination embedding space are, respectively, of a single embedding type.

17. The system of claim 15, wherein the multiple embedding distance function deep learning model is selected to determine the learned distance function model when the source embedding space and the destination embedding space include, respectively, two or more embedding types.

18. The system of claim 10, wherein generating the filtered candidate pool comprises applying one or more of a rules-based candidate knockout or an approximate nearest neighbor (ANN) search to the initial candidate pool.

19. A computer program product comprising a computer readable storage medium having program instructions embodied therewith, the program instructions executable by one or more processors to cause the one or more processors to perform operations comprising:
receiving a request for a candidate pair comprising a first entity and a second entity;
generating a filtered candidate pool comprising a first number of candidates, the filtered candidate pool comprising a subset of an initial candidate pool comprising a second number of candidates larger than the first number of candidates;
selecting a learned distance function from a plurality of distance functions, wherein at least one distance function was predetermined prior to receiving the request and at least one distance function is generated in response to receiving the request;
determining a distance measure for each candidate in the filtered candidate pool using the learned distance function; and
returning, responsive to receiving the request, a response comprising a top K candidates having a lowest distance measure of the determined distance measures.

20. The computer program product of claim 19, wherein selecting a learned distance function from a plurality of distance functions comprises determining a source embedding space for the first entity and a destination embedding space for the second entity.
